(19) United States
(12) Patent Application Publication
(10) Pub. No.: US 2007/0114785 A1
(43) Pub. Date: May 24, 2007

(54) DOCUMENT TABLET INCOPORATING A TRANSPARENT ADHESIVE HOLOGRAPHIC/NON-HOLOGRAPHIC SECURITY FILM OVERLAY BETWEEN PAGES IN THE TABLET FOR MECHANICALLY PROTECTING LOCATIONS ON THE DOCUMENT

(75) Inventor: Stephan S. Porter, Palm Beach Gardens, FL (US)

Correspondence Address: HOWISON & ARNOTT, L.L.P, P.O. BOX 741715, DALLAS, TX, 75374-1715, US

(73) Assignee: iTHINK, INC., WEST PALM BEACH, FL (US)

(21) Appl. No.: 11/539,591

(22) Filed: Oct. 6, 2006

Related U.S. Application Data
(60) Provisional application No. 60/724,120, filed on Oct. 6, 2005.

(51) Int. Cl. B42D 15/00

(52) U.S. Cl. 283/58

(57) ABSTRACT

A transparent tamper-evident holographic/non-holographic security film incorporated into a check book or prescription tablet that is easily accessible when the user writes on each check or prescription sheet in the tablet. The security film may be incorporated into the prescription or check document itself or be positioned on the front or back side of a receipt page associated therewith.

### CROSS-REFERENCE TO RELATED APPLICATIONS

This application claims priority of Provisional Patent Application No. 60/724120 which was filed on Oct. 6, 2005.

### BACKGROUND OF THE INVENTION

Embodiments of the invention provide a method and apparatus for mitigating the ability of creating a fraudulent document that requires a handwritten marking. More particularly, embodiments of the present invention mitigate an unauthorized person from attempting to mark or sign a check, prescription or other document.

Some of the fastest growing document crimes in America today are check fraud, prescription fraud, and identity theft. More than 1.2 million worthless checks enter the banking system each day. A recent Nilson Report advises that annual check fraud losses now exceed $20 billion, which is up from $12 billion in 1996 and $5 billion in 1993 and nearly 10 times credit card fraud. The American Bankers Association reports that check fraud is growing 25 percent per year. Historically, the banks have been liable for these losses however; recent changes in the Uniform Commercial Code (UCC) shift sole responsibility for check fraud losses from the bank and distribute it to both the bank and its customers. Fraud losses and related expenses will continue to increase until banks and customers form a strong partnership to prevent and control the problem.

Furthermore, fraudulent prescriptions for a variety of medications continue to be a growing problem. Pharmacists ay not be sure tat a given prescription slip was properly signed by the indicated physician and not forged by a third party. The pharmaceutical industry estimates that millions of fraudulent prescriptions are filled by pharmacies each year.

What is needed is an apparatus and method that mitigates the ability of a third party to alter a document, check or prescription from being altered after an authorized party has manually signed the document.

### SUMMARY OF THE INVENTION

Several security features have been developed and in some cases patented in an effort to help prevent or mitigate checks from being altered after being issued. Such security features include: 1) The use of controlled paper stock that is difficult to copy or manufacture; 2) Incorporating the use of fluorescent ink on the front or backside of a check. Such fluorescent ink becomes visible under ultraviolet light, 3) The use of fluorescent fibers in the paper stock that the check is comprised of. The fluorescent fibers become visible under ultraviolet light, 4) Making the check sensitive or reactive to predetermined chemicals, 5) Toner Anchorage that anchors the print toner to the paper stock, 6) The use of copy void pantograph technology, 7) The use of micro printing on the front or back of the check, 8) placing overt security features on or associated with the document or check, 9) Using thermo chromatic ink to identify the document such as a pink lock and key icons that fades away when warmed above 90° and reappears at 78°. This reaction cannot be replicated by a color copier, 10) The use of a Fourdrinier watermark, which is a true watermark that is visible from either side when the check or other document is held toward a light source. This type of watermark cannot be color copied or scanned, 11) Include a high resolution border on the document that is very difficult to copy, 12) Incorporate prismatic printing into the document or check, 13) Use of explicit warnings on the check or document, 14) Using a Chemical Wash Detection Box or location on the check or document, 15) the use of sequenced Inventory control numbers, and 16) the use of laid lines on the document or check.

Most previous solutions have focused on developing security check paper and optical security features that ensure that a check is an original and not a photocopy. Unfortunately, the vast majority of checks offered today have but only a few of these security features incorporated into their design and worse yet, the majority of all checks distributed today are hand written. Although a special ink pen has been developed by the uni-ball Corporation (the uni-ball 207) that contains color pigments, which are absorbed into a check's paper fibers and when an individual tries to “wash” the information written on the check, the ink is in effect trapped; very few consumers are aware of these security features and worse yet, the average consumer's routine use of special pens and other security features will continue to be hindered unless a simple delivery system for their use is devised. Since the main problem with hand written checks is (1) the ink can be removed and reapplied in different amounts and to a different payee, (2) the handwritten numbers themselves can be accessed and modified, and finally (3) because additional information can be added on critical areas of the check. It makes sense to establish a barrier that helps to prevent a criminal from having access to these vulnerable areas on the check and access to the handwritten information on the check. Most previous security features, including the development of the uni-ball 207 ink is an attempt to prevent alteration of the ink on handwritten checks. A barrier to these areas may be more advantageous because establishing a system and method of applying such a barrier does not rely on the use of special pens, inks or other ink/print/font/toner lock technologies.

To date transparent, tamper-evident holographic/non-holographic security films have been developed to cover signatures and other “alterable” information on documents. Some transparent hologram labels are available with a tamper evident feature. If an attempt is made to remove the label from the product or document, or to reposition it, the image self-destructs. This is an additional security feature.

Polyester or other types of security labels and films 10 may use a selective release or adhesive that leaves a pattern of dots 12 on the document 14 if the polyester label is removed there from as shown in FIGS. 1A and 1B.

These security films 10 are placed over the item in the document that is to be secured. Since the applied film is transparent and allows full visual access to the underlying words or image, including scanning of the underlying image which is a requirement of check 21 regulations whereby the original check is scanned then destroyed. Also, careful positioning of the security film 10 will not interfere with MICR (magnetic image character recognition) reading of the MICR numbers at the bottom of the check. These products can be used for securing information on a bank check, but is cumbersome to use routinely as they have to be carried separate from the check and applied by hand which can lead to inaccurate placement of the security film.

Embodiments of the present invention provide a delivery method for check book or prescription pad related security film solves the problem of being an inconvenience for the consumer or user.

### BRIEF DESCRIPTION OF THE DRAWINGS

For a more complete understanding of the present invention and the advantages thereof, reference is now made to the following description taken in conjunction with the accompanying Drawings in which:

FIGS. 1A and 1B illustrate a polymer film that may be applied in some embodiments of the present invention;

FIG. 2 illustrates an exemplary embodiment of the present invention;

FIG. 3 illustrates a transparent film being used in an embodiment of the present invention; and

FIG. 4 illustrates; another embodiment of the present invention.

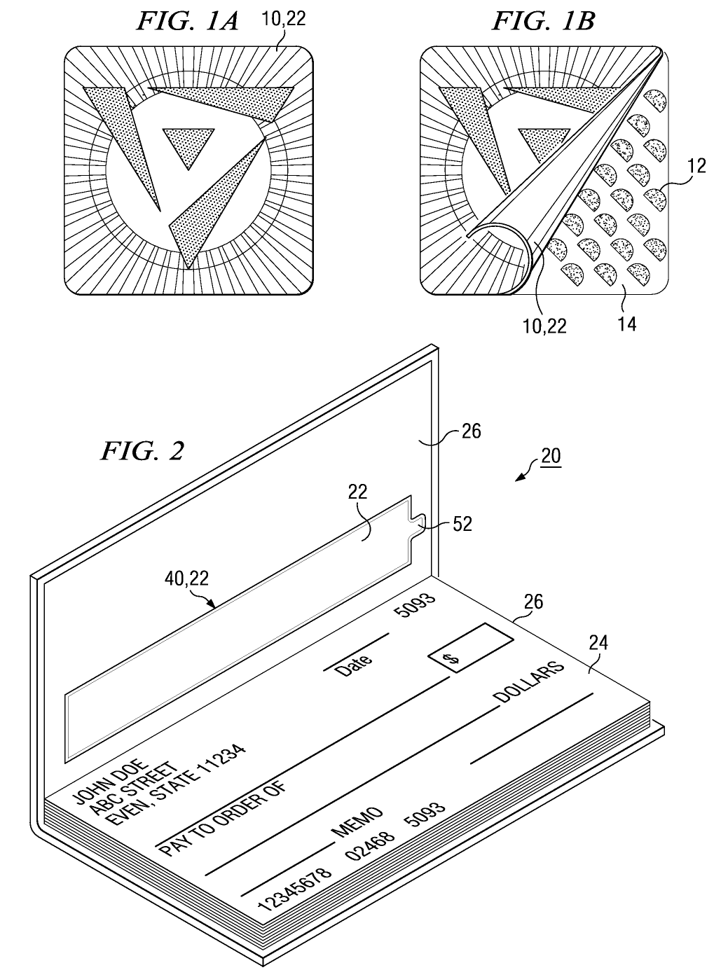

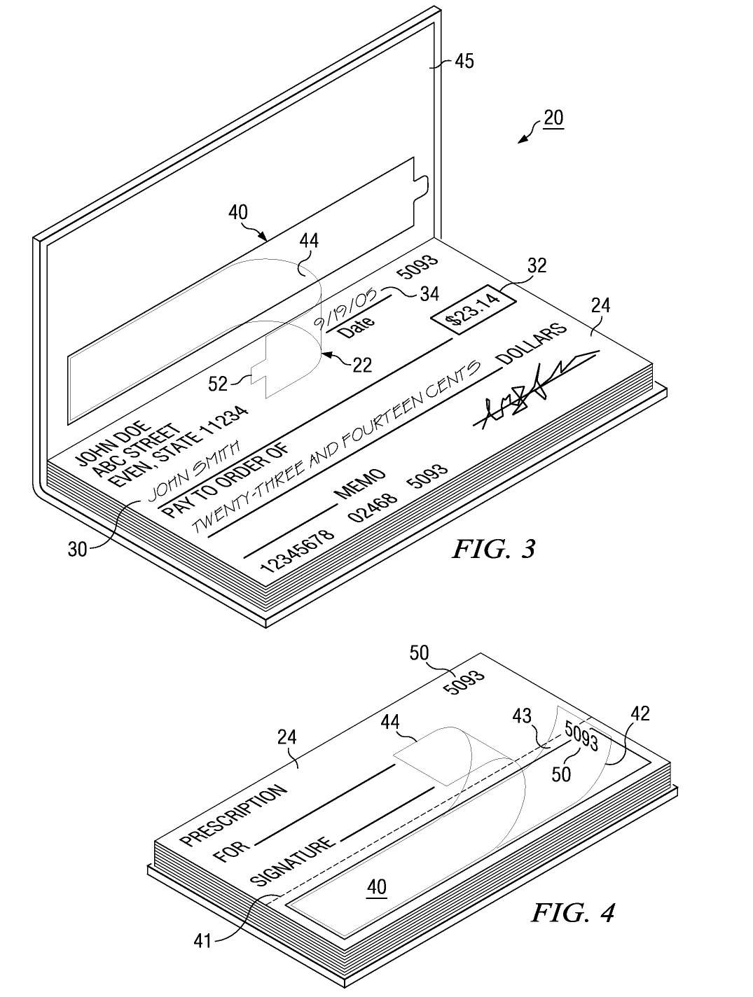

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

FIG. 2 depicts an exemplary checkbook 20 in accordance with an embodiment of the invention. A transparent tamper-evident holographic or non-holographic security film 22 is applied to signature 24 or other areas of a check, prescription or document that the user would like to protect from tampering by an unauthorized third party.

The transparent tamper-evident holographic/non-holographic security film 22 may be interposed between individual checks 26 or prescription sheets in a booklet, and/or in front of the check to be secured (similar to the duplicate receipt feature being placed behind the check). The exemplary security film 22 is instantly available to the user after a check 24 is filled out. Unlike duplicate checks, which have a pressure-sensitive “receipt” behind the check, a transparent tamper-evident holographic/non-holographic security film 22 with an adhesive bottom and non-adhesive top is placed on the front of the check 24 to be covered with the adhesive bottom side down on the check front. Once the check 24 is filled out with payee 30, amount 32, date 34 etc. (see FIG. 4), the security film non-adhesive top is removed and the sheet pressed against the face of the check 24. As the non-adhesive top sheet is then removed, the transparent tamper-evident holographic/non-holographic security film is left attached and adhered to the areas of the check to be protected. Because different check manufacturers and printers position the check fields in different positions on their particular checks, by having the transparent tamper-evident holographic/non-holographic security film interposed between individual checks and incorporated into the check booklet binder, the accurate position of the transparent tamper-evident holographic/non-holographic security film can be assured for each check manufacturer and check printer.

FIG. 4 shows an exemplary transparent tamper-evident holographic/non-holographic security film composition 40 in accordance with an embodiment of the invention. The film 40 is made up of a plurality of layers. The bottom layer 22 is the transparent tamper-evident holographic/non-holographic security film. The bottom side 42 the transparent film has adhesive thereon for sticking or adhering the film 22 to the document, check 24 or prescription. The top layer 44 of the security film 40 is the non-adhesive top-sheet 44 that is removed after the security film composition 40 is properly placed on the document thereby leaving the transparent tamper-evident film 22 covering the secured portion of the document.

Alternatively, the security sheet and film can be attached to the front or back side of each check or document 24 along its sides or lower edge or other convenient locations (as also shown in FIG. 4).

In another embodiment of the invention the transparent tamper-evident holographic/non-holographic security film 22 and/or the composition 40 may be positioned on the back of the duplicate check sheet 45 being attached with a light adhesive (not specifically shown). To activate the security film 22, the protective cover 44 is peeled off the film; the duplicate check lowered and pressed on the underlying check, then lifted leaving behind the security film. In this embodiment the security film 22 has adhesive on its top side 43, but no adhesive on its bottom side 42. Advantages of this technique are multiple; (1) the security film is accurately positioned over the check information to be secured, (2) by attaching the security film to the duplicate check, the need to have a stand-alone “additional” sheet interposed between checks is eliminated, and (3) the transparent security film may prevent the impression-transfer of information from the above check through to the underlying duplicate check.

Another embodiment of the invention provides a stand alone sheet 40 that has a positioning template that is purchased and carried separate of the booklet of checks with the same “peel and press” application technique.

Additionally, because the transparent tamper-evident holographic/non-holographic security film is contained within the booklet of checks, consumer acceptance and use will be significant.

The transparent tamper-evident holographic/non-holographic security film can be combined with ring binder-ledger type business checks.

Additional security can be incorporated into the transparent tamper-evident holographic/non-holographic security film and include having a metallic holographic strip in the security film 22 that is difficult to duplicate or that is incorporates a check number or other user oriented indicia such as a check number, bank number, bank name, user name or otherwise. The security film 22 may incorporate the matching check number 50 so that only one strip is available for protecting each check or prescription sheet in the booklet. Security warnings (not specifically shown) may be printed on the document 24 or the security film 22. The security film may also incorporate reflective technology that provides a visible VOID if the security film 22 is photocopied. The word “VOID” or other indicia may not be easily visible under normal lighting conditions. Furthermore, a residual Void adhesive track or other design (e.g. dots) may be left behind on the document if the transparent tamper-evident holographic/non-holographic security film 22 is removed

One advantage of this approach to check security is that the transparent tamper-evident holographic/non-holographic security film immediately and strongly mitigates, through mechanical means, access to critical check, prescription or document data including Payee, amount, medication, quantity, dosage, authorized signature that could otherwise be altered by ink washing, overwriting with a larger font or darker ink or other means of mechanical alteration of inked information. Since the “peel and press” (“peel and seal”) design of the transparent tamper-evident holographic/non-holographic security film 22, 40 allows the consumer immediate access to the security feature, it will be conveniently used with each bank check, prescription or document and requires minimal change in a consumer's “check-writing” or medical practitioner's “prescription-writing” behavior to assure acceptance.

Another alternative to this approach incorporates the transparent tamper-evident holographic/non-holographic security film 22 being supplied on a non-adhesive template that is custom designed by the check manufacturer or printer to accurately place each security overlay in the appropriate position on the particular check or check design.

Embodiments of this invention combines the mechanical security features offered by a transparent tamper-evident holographic/non-holographic security film along with the ease of film 22 availability and delivery afforded by interposing the security film 40, 22 between individual bank checks, either single or duplicate bound within a booklet. The “cut-out”, “pull-tab” 52 access window may be a branding feature for embodiments of the invention. Additionally, a branding logo may be provided only on checkbooks, a prescription tablets other document tablets that incorporate features of the present invention. This will assure product branding. The corresponding check number 50 can be imprinted on the security film 22 to match the check's 24 check number 50. The film can be made to self destruct with VOID being the result.

Additionally, another security threat to checks and prescription tablets occurs when a checkbook or tablet with “duplicate” receipts is lost or stolen. The reason for concern is that with duplicate checks or prescriptions, the original signature that is signed on the check or prescription is transferred through to a duplicate, pressure sensitive “duplicate” paper receipt. As such, the criminal has access to not only the checkbook or prescription tablet containing “blank checks or script sheets”, but also has the check account owner's or physician's signature, captured on the “duplicate” receipt. An exemplary solution to this potential security breach is to block the transfer of the signature to the “duplicate” check receipt. The “BLOCKING” of the signature transfer can be accomplished in many ways; (1) cut out a rectangular area of the pressure sensitive “duplicate” receipt so that the signature has nothing to transfer to; (2) add a second plastic flap that interposes between the check and the duplicate receipt to prevent transfer of the signature, like the plastic flap that is positioned behind the duplicate check receipt and the underlying check to prevent transfer of pressure from one check to the next; or (3) place the protective, transparent security film 40, 22, like the ones in the exemplary embodiments, over the signature area on the duplicate check receipt to prevent the pressure from the overlying check being transferred and marking the underlying “duplicate” check receipt in the signature area. This will provide prevention of the transfer of the signature, either in part or total to the underlying “duplicate” check receipt and the criminal element will then not ample access to the checking account holders' signature from which to write and sign fraudulent checks.

It will be appreciated by those skilled in the art having the benefit of this disclosure that this invention provides a protective film that is easily available in a check, prescription, or other document tablet for covering signature and other hand written information placed on the document in order to mitigate tampering with the document. The placement of the protective film within the checkbook or prescription booklet is important in that it must easily accessible to the user and available for each check or prescription written. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A document tablet comprising:
a plurality of document pages in the document tablet, each document page having a location that is to be filled in with handwriting of a user;
a security film composition incorporated into document pages of said document tablet, said security film composition comprising:
a bottom layer comprising a transparent film with an adhesive on one side for adhering said transparent film to a document, and
a top layer that is removed from said bottom layer.
